(19) United States
(12) Patent Application Publication
(10) Pub. No.: US 2023/0273339 A1
(43) Pub. Date: Aug. 31, 2023

(54) METHOD FOR DETERMINING THE STIMULATED RESERVIOR VOLUME OF HORIZONTAL WELLS BY COUPLING RESERVOIR FLOW

(71) Applicant: Southwest Petroleum University, Chengdu (CN)

(72) Inventors: Yongming LI, Chengdu (CN); Ang LUO, Chengdu (CN); Yu PENG, Chengdu (CN); Xuefeng YANG, Chengdu (CN); Cheng CHANG, Chengdu (CN)

(73) Assignee: Southwest Petroleum University, Chengdu (CN)

(21) Appl. No.: 18/151,398

(22) Filed: Jan. 6, 2023

(30) Foreign Application Priority Data
Feb. 28, 2022 (CN) 202210189951.2

(51) Int. Cl. G01V 99/00; G06F 30/28

(52) U.S. Cl. CPC G01V 99/005; G06F 30/28; E21B 2200/20; E21B 43/26

(57) ABSTRACT

The present invention discloses a method for determining the stimulated reservoir volume of horizontal wells by coupling reservoir flow, comprising the following steps: establishing a reservoir grid based on the reservoir geological model of the target well and adding an initial fracture unit; calculating the stress intensity factor at the fracture tip, judging the fracture initiation and determining the total number of fracture units; calculating the fluid pressure of fracture units, the pore pressure distribution and water saturation distribution of the reservoir matrix and micro-fractures during hydraulic fracturing; working out the stimulated reservoir volume of the horizontal well according to the fracture parameters, pressure distribution and water saturation distribution in shale reservoirs. The present invention can simulate fracture propagation, fracturing fluid leak-off and reservoir fluid flow in the whole fracturing process, determine the stimulated reservoir volume of horizontal wells.

### CROSS-REFERENCE TO RELATED APPLICATIONS

The application claims priority to Chinese patent application No. 202210189951.2, filed on Feb. 28, 2022, the entire contents of which are incorporated herein by reference.

### TECHNICAL FIELD

The present invention pertains to the technical field of oil and gas reservoir development, in particular to a method for determining the stimulated reservoir volume of horizontal wells by coupling reservoir flow.

### BACKGROUND

At present, volume fracturing is an indispensable technology in the efficient development of shale gas reservoirs. The size of the stimulated reservoir volume directly determines the evaluation of fracturing stimulation effectiveness and estimated ultimate recovery (EUR) for a single well. Therefore, it is of great significance to determine the stimulated reservoir volume of horizontal wells to improve the development efficiency of oil and gas reservoirs.

During the fracturing operation of shale gas wells, the fracturing fluid will be continuously leaked into the reservoir through the matrix and fracture, and the formation pressure is propagated deeper into the reservoir, leading to changes in the pore structure of the reservoir around the fractures, thus expanding the stimulated reservoir volume. At present, there are many methods to determine the stimulated reservoir volume of horizontal wells, but the above effects are not considered in these methods, making it impossible to calculate the affecting range of fracturing fluid in the reservoir and work out the distribution of reservoir pressure and water saturation, so that the final results of stimulated reservoir volume are not accurate.

### SUMMARY

In view of the above problems, the present invention aims to provide a method for determining the stimulated reservoir volume of horizontal wells by coupling reservoir flow. With this method, the flow of reservoir fluid during fracturing is considered to analyze and determine the stimulated reservoir volume on the basis of obtained water saturation field and fracturing fluid leak-off in the reservoir, so as to obtain more accurate results of stimulated reservoir volume.

The technical solution of the present invention is as follows:

A method for determining the stimulated reservoir volume of horizontal wells by coupling reservoir flow, comprising the following steps:

Step 1: Obtain the reservoir geological model of the target well, establish the reservoir grid of the target well based on the reservoir geological model, and add initial fractures of each cluster to the reservoir grid, making initial fractures divided into multiple fracture units by the reservoir grid;

The total number of hydraulic fracture tips in the reservoir grid is defined as U, and the number of fracture tips is e, then e=1, 2 . . . , U−1 and U; if e is an odd number, it represents the upper tip of the fracture, and if e is an even number, it represents the lower tip of the fracture; let n_{L} denote the total number of fracture units and let L denote the fracture unit number, then L=1, 2 . . . n_{L}−1 and n_{L}; let ξ_{L} represent the length of the L^{th} fracture unit, P_{F,L} represent the fluid pressure in the L^{th} fracture unit, T_{F,L} represent the initiation time of the L^{th} fracture unit, and to represent the initiation time of the initial fracture unit of each cluster;

Step 2: Calculate the stress intensity factor at the e^{th} fracture tip at t₀ based on the boundary element displacement discontinuity method;

Step 3: Determine whether the fracture propagates at the e^{th} fracture tip at t₀ according to the stress intensity factor at the e^{th} fracture tip at t₀:

If the fracture does not propagate at the e^{th} fracture tip, repeat Steps 2 and 3, calculate the stress intensity factor at the e+1^{th} fracture tip at t₀, and judge whether the fracture propagates at the e+1^{th} fracture tip at t₀;

If the fracture propagates at the e^{th} fracture tip, the fracture at the e^{th} fracture tip is increased by one fracture unit in the direction of the e^{th} fracture tip, and the total number of fracture units is n_{L}=n_{L}+1; the fluid pressure of the added fracture unit is the same as that of the adjacent fracture unit, and the initiation time of the added fracture unit is designated as T_{F,nL+1}=t₀; repeat Steps 2 and 3, calculate the stress intensity factor at the e+1^{th} fracture tip at t₀ based on the data after adding the fracture unit, and judge whether the fracture propagates at the e+1^{th} fracture tip at t₀;

After the judgment of fracture propagation at all fracture tips, the total number n_{L,t0} of fracture units after fracture propagation at t₀ can be obtained, and the number of fracture unit is L=1, 2, . . . , n_{L,t0}−1, and n_{L,t0}; the initiation time of the L^{th} fracture unit at t₀ is defined as T_{F,L,t0} and the fluid pressure in the L^{th} fracture unit at t₀ as P_{F,L,t0};

Step 4: Based on the data obtained in Step 3, employ the gas-water dual medium seepage model for numerical calculation in combination with the embedded discrete fractures to obtain the fluid pressure of hydraulic fracture units, the pressure distribution in the matrix system, the water saturation distribution in the matrix system, the pressure distribution in the micro-fracture system, and the water saturation distribution in the micro-fracture system at t₁ during fracturing operation;

Step 5: Based on the data obtained in Step 4, repeat Step 2 to 4, and calculate the fluid pressure in the hydraulic fracture unit, the pressure distribution in the matrix system, the water saturation distribution in the matrix system, the pressure distribution in the micro-fracture system, and the water saturation distribution in the micro-fracture system at t₂;

Step 6: Repeat Step 5 until the time reaches the fracturing time t_{end} to obtain the number of hydraulic fracture units, water saturation distribution of matrix system and water saturation distribution of micro-fracture system at t_{end};

Step 7: Calculate the stimulated reservoir volume at t_{end} according to the data obtained in Step 6.

Preferably, in Step 1, the reservoir grid is a structured grid with a grid number of nᵢ×nⱼ in x-y coordinate system, wherein x_{i,j} and y_{i,j} represent the length and width of each grid respectively and the subscripts i and j represent the position of each grid in the reservoir; there are matrix system and micro-fracture system in each grid, constituting a dual medium model; the initial pressure of the matrix system and the micro-fracture system is the original formation pressure, and the water saturation of the matrix system and the micro-fracture system is the original formation water saturation.

Preferably, in Step 1, when the initial fracture unit of each cluster is added to the reservoir grid, the direction of initial fracture unit of each cluster is designated as y-axis direction, and the length of initial fracture unit of each cluster is the length of N grids (N≥3).

Preferably, Step 2 specifically comprises the following sub-steps:

Step 2-1: Assuming that the fluid pressure in each fracture unit is the same, the fluid pressure at the fracture tip is equal to the fluid pressure in the fracture unit at the fracture tip at t₀;

Step 2-2: Determine the coordinates of the upper and lower tip positions of each fracture cluster in the x-y coordinate system according to the fracture unit position in to, which are respectively denoted as (x₁,y₁), . . . , (xₑ,yₑ);

Step 2-3: Take the center of the first fracture unit as the origin, the extension direction of the first fracture unit as the y̅ direction and the direction perpendicular to the extension of the first fracture unit as the x̅ direction, establish a local x̅-y̅ coordinate system, and convert the position coordinates of all fracture tips in Step 2-2 into the position coordinates in the local x̅-y̅ coordinate system, which are respectively denoted as (x̅₁, y̅₁), . . . , (x̅ₑ, y̅ₑ);

Step 2-4: Calculate the normal discontinuous displacement of the first, second, . . . , and n_{L}^{th} fracture unit at the e^{th} fracture tip at t₀;

Step 2-5: Overlay all the normal discontinuous displacements at the e^{th} fracture tip calculated in Step 2-4, and calculate the stress intensity factor at the e^{th} fracture tip at t₀ with the stress intensity factor calculation model at the fracture tip on the basis of the overlaid normal discontinuous displacement.

Preferably, in Step 2-4, the normal discontinuous displacement of the first fracture unit at the e^{th} fracture tip at t₀ can be calculated by the following equation:

$${D}_{1 , e , {t}_{0}} = \frac{{P}_{e , {t}_{0}} - {σ}_{h}}{{A}_{xx ( 1 , e )} {sin}^{2} ( 2 {α}_{1} ) - {A}_{xy ( 1 , e )} sin {α}_{1} + {A}_{yy ( 1 , e )} {cos}^{2} ( 2 {α}_{1} )} \qquad ( 1 )$$

$$\{ \begin{matrix}{A}_{xx ( 1 , e )} = \frac{E}{1 + υ} [ {f}_{a ( 1 , e )} + {\overline{y}}_{e} ( sin {α}_{1} \times {f}_{c ( 1 , e )} + cos {α}_{1} \times {f}_{b ( 1 , e )} ) ] \\ {A}_{yy ( 1 , e )} = \frac{E}{1 + υ} [ {f}_{a ( 1 , e )} - {\overline{y}}_{e} ( sin {α}_{1} \times {f}_{c ( 1 , e )} + cos {α}_{1} \times {f}_{b ( 1 , e )} ) ] \\ {A}_{xy ( 1 , e )} = \frac{E}{1 + υ} [ - {\overline{y}}_{e} ( cos {α}_{1} \times {f}_{c ( 1 , e )} + sin {α}_{1} \times {f}_{b ( 1 , e )} ) ]\end{matrix} \qquad ( 2 )$$

$$\{ \begin{matrix}{f}_{a ( 1 , e )} = \frac{- 1}{4 π ( 1 - υ )} [ \frac{{\overline{x}}_{e} - \frac{{ξ}_{1}}{2}}{{( {\overline{x}}_{e} - \frac{{ξ}_{1}}{2} )}^{2} + {\overline{y}}_{e}^{2}} - \frac{{\overline{x}}_{e} + \frac{{ξ}_{1}}{2}}{{( {\overline{x}}_{e} + \frac{{ξ}_{1}}{2} )}^{2} + {\overline{y}}_{e}^{2}} ] \\ {f}_{b ( 1 , e )} = \frac{1}{4 π ( 1 - υ )} [ \frac{{( {\overline{x}}_{e} - \frac{{ξ}_{1}}{2} )}^{2} - {\overline{y}}_{e}^{2}}{{[ {( {\overline{x}}_{e} - \frac{{ξ}_{1}}{2} )}^{2} + {\overline{y}}_{e}^{2} ]}^{2}} - \frac{{( {\overline{x}}_{e} + \frac{{ξ}_{1}}{2} )}^{2} - {\overline{y}}_{e}^{2}}{{[ {( {\overline{x}}_{e} + \frac{{ξ}_{1}}{2} )}^{2} + {\overline{y}}_{e}^{2} ]}^{2}} ] \\ {f}_{c ( 1 , e )} = \frac{2 {\overline{y}}_{e}}{4 π ( 1 - υ )} [ \frac{{\overline{x}}_{e} - \frac{{ξ}_{1}}{2}}{{[ {( {\overline{x}}_{e} - \frac{{ξ}_{1}}{2} )}^{2} + {\overline{y}}_{e}^{2} ]}^{2}} - \frac{{\overline{x}}_{e} + \frac{{ξ}_{1}}{2}}{{[ {( {\overline{x}}_{e} + \frac{{ξ}_{1}}{2} )}^{2} + {\overline{y}}_{e}^{2} ]}^{2}} ]\end{matrix} \qquad ( 3 )$$

Where, D_{1,e,t0} is the normal discontinuous displacement generated by the first fracture unit at the e^{th} fracture tip at t₀, in mm; P_{e,t0} is the fluid pressure at the e^{th} fracture tip at t₀, in MPa; σₕ is the minimum horizontal principal stress of the reservoir, in MPa; A_{xx(1,e)}, A_{xy(1,e)}, A_{yy(1,e)}, f_{a(1,e)}, f_{b(1,e)} and f_{c(1,e)} are all intermediate functions in the calculation process; α₁ is the angle between the x-axis of the local x̅-y̅ coordinate system of the first fracture unit and the x̅-axis of the x-y coordinate system; E is Young's modulus of reservoir rocks, in GPa; υ is Poisson's ratio of reservoir rock; x̅ₑ and y̅ₑ are the coordinates of the e^{th} fracture tip in the local x̅-y̅ coordinate system of the first fracture unit; ξ₁ is the length of the first fracture unit, in m;

In Step 2-4, the method for calculating the normal discontinuous displacement of the second, . . . , n_{L}^{th} fracture unit at the e^{th} fracture tip at t₀ is the same as that for the normal discontinuous displacement of the first fracture unit at the e^{th} fracture tip at t₀, so that Equations (1) to (3) are used to calculated the normal discontinuous displacement of the second, . . . , and n_{L}^{th} fracture unit at the e^{th} fracture tip at t₀.

Preferably, in Step 2-5, the calculation model of the stress intensity factor at the fracture tip is as follows:

$${K}_{I , e , {t}_{0}} = \frac{E}{4 ( 1 - {υ}^{2} )} \sqrt{\frac{π}{2 {r}_{e}}} {D}_{e , {t}_{0}} \qquad ( 4 )$$

$${D}_{e , {t}_{0}} = {\sum }_{L = 1}^{{n}_{L}} {D}_{L , e , {t}_{0}} \qquad ( 5 )$$

Where, K_{I,e,t0} is the stress intensity factor at the e^{th} fracture tip at t₀, in MPa\sqrt{m}; rₑ is the half length of fracture unit at the e^{th} fracture tip, in mm; D_{e,t0} is the total normal discontinuous displacement at the e^{th} fracture tip at t₀, in mm; D_{L,e,t0} is the normal discontinuous displacement generated by the L^{th} fracture unit at the tip of the e¹ fracture at t₀, in mm.

Preferably, in Step 3, the method to judge whether the fracture propagates at the e^{th} fracture tip at t₀ is as follows:

The stress intensity factor K_{I,e,t0} at the e^{th} fracture tip at t₀ is compared with the fracture toughness K_{IC} of the reservoir rock: if K_{I,e,t0}≤K_{IC}, the fracture does not propagate at the e^{th} fracture tip; if K_{I,e,t0}>K_{IC}, the fracture will propagate at the e^{th} fracture tip.

Preferably, in Step 4, the gas-water dual medium seepage model comprises:

(1) Model of leak-off from hydraulic fracture unit to micro-fracture:

$${Q}_{F - fw} = \frac{C}{\sqrt{T - {T}_{F}}} \frac{2 {K}_{f} {l}_{F} H}{{μ}_{w} {\overline{d}}_{F - f}} ( {P}_{F} - {P}_{fw} ) \qquad ( 6 )$$

$${\overline{d}}_{F - f} = \frac{1}{{A}_{f}} \int {l}_{F - f} {dA}_{f} \qquad ( 7 )$$

Where, Q_{F-fw} is the leak-off between the hydraulic fracture unit and the micro-fracture grid, in m³; C is the leak-off coefficient; T is the current moment, in s; T_{F} is the initiation time of hydraulic fracture unit, T_{F}=T_{F,L,t0} and L=1, 2, . . . , n_{L,t0}−1, n_{L,t0}; K_{f} is the permeability of micro-fracture grid, D; l_{F} is the length of hydraulic fracture unit, in m, l_{F}=ξ_{L} and L=1, 2, . . . , n_{L,t0}−1,n_{L,t0}; H is reservoir thickness, in m; μ_{w} is the viscosity of fracturing fluid, in mPa·s; d̅_{F-f} is the average normal distance from one point in the micro-fracture grid to one hydraulic fracture unit, in m; P_{F} is the fluid pressure of hydraulic fracture unit, in MPa, P_{F}=P_{F,L,t0} and L=1, 2, . . . , n_{L,t0}−1,n_{L,t0}; P_{fw} is the water pressure of micro-fracture grid, in MPa; A_{f} is the area of micro-fracture grid, in m²; l_{F-f} is the distance between the area unit of micro-fracture grid and the fracture k, in m;

(2) Single-phase flow in hydraulic fracturing:

$$\frac{\partial }{\partial ξ} ( \frac{β {K}_{F}}{{μ}_{w} {B}_{w}} \frac{\partial {P}_{F}}{\partial ξ} ) + {δ}_{well} \frac{{q}_{{F}_{w}}}{{V}_{F}} + \frac{{Q}_{F - fw}}{{V}_{F}} = \frac{\partial }{\partial t} ( \frac{{ϕ}_{F}}{{B}_{W}} ) \qquad ( 8 )$$

$${q}_{Fw} = \frac{2 π β {K}_{F} {w}_{F} ( {P}_{F} - {P}_{wf} )}{{μ}_{w} {B}_{w} [ ln ( \frac{{r}_{eq}}{{r}_{well}} ) + s ]} \qquad ( 9 )$$

$${r}_{eq} = {0.14 [ {( {l}_{F} )}^{2} + {( {H}_{F} )}^{2} ]}^{1 / 2} \qquad ( 10 )$$

Where, β is the unit conversion coefficient; K_{F} is the permeability of hydraulic fracture, D; B_{w} is the volume coefficient of fracturing fluid; δ_{well} is the coefficient to judge the intersection relationship between hydraulic fracture unit and wellbore; if the fracture unit intersects with the wellbore, δ_{well}=1; if not intersect, δ_{well}=0; q_{Fw} is flow exchange between hydraulic fracture unit and wellbore, in m³; V_{F} is the volume of hydraulic fracture unit, in m³; ϕ_{F} is the porosity of hydraulic fracture, in %; w_{F} is the width of hydraulic fracture unit, in m; P_{wf} is the flow pressure at the bottom of the well, in MPa; r_{eq} is effective radius, in m; r_{well} is wellbore radius, in m; s is surface coefficient; H_{F} is the height of hydraulic fracture unit, in m;

(3) Seepage model of matrix and micro-fracture systems during fracturing:

$$∇ ( β \frac{{K}_{f} {K}_{frw}}{{μ}_{w} {B}_{w}} ∇ {P}_{fw} ) - {δ}_{f} \frac{{Q}_{F - fw}}{{V}_{f}} + \frac{β {K}_{m} {K}_{mrw}}{{μ}_{w} {B}_{w}} ( {P}_{mw} - {P}_{fw} ) = \frac{\partial }{\partial t} ( \frac{{ϕ}_{f} {S}_{fw}}{{B}_{w}} ) \qquad ( 11 )$$

$$∇ ( β \frac{{K}_{f} {K}_{frg}}{{μ}_{g} {B}_{g}} ∇ {P}_{fg} ) + \frac{β {K}_{m} {K}_{mrg}}{{μ}_{g} {B}_{g}} ( {P}_{mg} - {P}_{fg} ) = \frac{\partial }{\partial t} ( \frac{{ϕ}_{f} {S}_{fg}}{{B}_{g}} ) \qquad ( 12 )$$

$$∇ ( β \frac{{K}_{m} {K}_{mrw}}{{μ}_{w} {B}_{w}} ∇ {P}_{mw} ) - \frac{β {K}_{m} {K}_{mrw}}{{μ}_{w} {B}_{w}} ( {P}_{mw} - {P}_{fw} ) = \frac{\partial }{\partial t} ( \frac{{ϕ}_{m} {S}_{mw}}{{B}_{w}} ) \qquad ( 13 )$$

$$∇ ( β \frac{{K}_{m} {K}_{mrg}}{{μ}_{g} {B}_{g}} ∇ {P}_{mg} ) - \frac{β {K}_{m} {K}_{mrg}}{{μ}_{g} {B}_{g}} ( {P}_{mg} - {P}_{fg} ) = \frac{\partial }{\partial } ( \frac{{ϕ}_{m} {S}_{mg}}{{B}_{g}} ) \qquad ( 14 )$$

$${P}_{mc} = {P}_{mg} - {P}_{mw} \qquad ( 15 )$$

$${P}_{fc} = {P}_{fg} - {P}_{fw} \qquad ( 16 )$$

Where, ∇ is Hamiltonian operator; K_{frw} and K_{frg} are the relative permeability of liquid and gas in the micro-fracture grid; δ_{f} is the parameter for judging whether the micro-fracture grid contains hydraulic fractures, when the micro-fracture grid is crossed by hydraulic fractures, δ_{f}=1; when the micro-fracture grid is not crossed by hydraulic fractures, δ_{f}=0; V_{f} is the volume of micro-fracture grid, in m³; Kₘ is matrix permeability, in mD; K_{mrw} and K_{mrg} are the relative permeability of liquid and gas in the micro-fracture grid; P_{mw} and P_{mg} are the pressure of liquid and gas in the matrix grid, in MPa; ϕ_{f} and ϕₘ are the porosity of micro-fracture and matrix, in %; S_{fw} and S_{fg} are the saturation of the liquid and gas in the micro-fracture grid; μ_{g} is the viscosity of gas, in mPa·s; B_{g} is the volume coefficient of gas; P_{fg} is the gas pressure of the micro-fracture grid, in MPa; S_{mw} and S_{mg} are the saturation of liquid and gas in the matrix grid; P_{fc} and P_{mc} are capillary forces of micro-fracture and matrix, in MPa;

(4) Initial conditions:

$$\{ \begin{matrix}{P}_{F} ( L ) = {P}_{F , L , {t}_{0}} \\ {P}_{fw} ( i , j ) = {P}_{fwi , j , {t}_{0}} \\ {P}_{mw} ( i , j ) = {P}_{mwi , j , {t}_{0}}\end{matrix} \qquad ( 17 )$$

$$\{ \begin{matrix}{S}_{fw} ( i , j ) = {S}_{fwi , j , {t}_{0}} \\ {S}_{mw} ( i , j ) = {S}_{mwi , j , {t}_{0}}\end{matrix} \qquad ( 18 )$$

$$\{ \begin{matrix}{T}_{F} ( L ) = {T}_{F , L , {t}_{0}} \\ T = {t}_{0}\end{matrix} \qquad ( 19 )$$

Where, P_{F}(L) is the fluid pressure of the L^{th} fracture unit in the seepage model calculation, in MPa; P_{fw(i,j)} and P_{mw(i,j)} are the liquid pressure of micro-fracture and matrix systems at the grid position of (i,j) in seepage model calculation, in MPa; P_{fw i,j,t0} and P_{mw i,j,t0} are the liquid pressure of micro-fracture and matrix systems at grid position (i,j) at t₀, in MPa; S_{fw(i,j)} and S_{mw(i,j)} are the water saturation of micro-fracture and matrix systems at the grid position of (i,j) in seepage model calculation; S_{fw i,j,t0} and S_{mw i,j,t0} are the water saturation of micro-fracture and matrix systems at grid position (i,j) at t₀; T_{F(L)} is the initiation time of the L^{th} fracture unit in the seepage model calculation, in s; T is the current time, in s.

Preferably, in Step 7, the stimulated reservoir volume can be calculated by the following equation:

$${V}_{0} = {\sum }_{i = 1}^{{n}_{i}} {\sum }_{j = 1}^{{n}_{j}} {α}_{1 , i , j} {x}_{i , j} {y}_{i , j} H {ϕ}_{m} + {\sum }_{i = 1}^{{n}_{i}} {\sum }_{j = 1}^{{n}_{j}} {α}_{2 , i , j} {x}_{i , j} {y}_{i , j} H {ϕ}_{f} + {L}_{F , {t}_{end}} {w}_{F} H \qquad ( 20 )$$

$${L}_{F , {t}_{end}} = {n}_{L , {t}_{end}} \times {ξ}_{L} \qquad ( 21 )$$

Where, V₀ is the stimulated reservoir volume, in m³; α_{1,i,j} is the judgment parameter of the fracturing stimulation range in the matrix system; when S_{mw i,j,tend}>S_{mw i,j,t0}, the matrix system at the (i,j) grid position is stimulated and α1,i,j=1; when S_{mw i,j,tend}≤S_{mw i,j,t0}, α_{1,i,j}=0; H is reservoir thickness, in m; ϕₘ is the porosity of the matrix, in %; α_{2,i,j} is the judgment parameter of the fracturing stimulation range in the micro-fracture system; when S_{fw i,j,tend}>S_{fw i,j,t0}, the micro-fracture system at the (i,j) grid position is stimulated and α_{2,i,j}=1; when S_{fw i,j,tend}≤S_{fw i,j,t0}, αa_{2,i,j}=0; ϕ_{f} is the porosity of micro-fracture, in %; L_{F,tend} is the length of hydraulic fracture after fracturing, in m; n_{L,tend} is the number of hydraulic fracture units at t_{end}.

The present invention has the following beneficial effects:

The present invention is combined with embedded discrete fracture model, boundary element displacement discontinuity method and reservoir dual medium model to simulate the fracture propagation, fracturing fluid leak-off and reservoir fluid flow, and then determines the stimulated reservoir volume based on the affecting range of fracturing. With high calculation efficiency, the present invention is better coupled with the reservoir flow in the fracture propagation, guiding the on-site construction in a timely and efficient manner. The invention can not only obtain fracture parameters after fracturing, but also obtain water saturation distribution and pressure distribution evolution in the whole fracturing process by coupling reservoir flow; furthermore, the stimulated reservoir volume of horizontal shale gas wells can be determined, providing a basis for fracturing effect evaluation of shale gas wells, EUR evaluation of single well and productivity simulation and promoting the efficient development of shale gas resources.

### BRIEF DESCRIPTION OF DRAWINGS

In order to explain the embodiments of the present invention or the technical solutions in the prior art more clearly, the following will make a brief introduction to the drawings needed in the description of the embodiments or the prior art. Obviously, the drawings in the following description are merely some embodiments of the present invention. For those of ordinary skill in the art, other drawings can be obtained based on the structures shown in these drawings without any creative effort.

FIG. 1 is a schematic diagram of the water saturation distribution of the matrix in a specific embodiment of the present invention;

FIG. 2 is a schematic diagram of the water saturation distribution of micro-fractures in a specific embodiment of the present invention.

### DETAILED DESCRIPTION OF THE EMBODIMENTS

The present invention is further described with reference to the drawings and embodiments. It should be noted that the embodiments in this application and the technical features in the embodiments can be combined with each other without conflict. It is to be noted that, unless otherwise specified, all technical and scientific terms herein have the same meaning as commonly understood by those of ordinary skill in the art to which this application belongs. “Include” or “comprise” and other similar words used in the present disclosure mean that the components or objects before the word cover the components or objects listed after the word and its equivalents, but do not exclude other components or objects.

The present invention provides a method for determining the stimulated reservoir volume of horizontal wells by coupling reservoir flow, comprising the following steps:

Step 1: Obtain the reservoir geological model of the target well, establish the reservoir grid of the target well based on the reservoir geological model, and add the initial fracture of each cluster to the reservoir grid, making initial fractures divided into multiple fracture units by the reservoir grid;

The total number of hydraulic fracture tips in the reservoir grid is defined as U, and the number of fracture tips is e, then e=1, 2 . . . , U−1 and U; if e is an odd number, it represents the upper tip of the fracture, and if e is an even number, it represents the lower tip of the fracture; let n_{L} denote the total number of fracture units and let L denote the fracture unit number, then L=1,2 . . . n_{L}−1 and n_{L}; let ξ_{L} represent the length of the L^{th} fracture unit, P_{F,L} represent the fluid pressure in the L^{th} fracture unit, T_{F,L} represent the initiation time of the L^{th} fracture unit, and t₀ represent the initiation time of the initial fracture unit of each cluster;

In a specific embodiment, the reservoir grid is a structured grid with a grid number of nᵢ×nⱼ in x-y coordinate system, wherein x_{i,j} and y_{i,j} represent the length and width of each grid respectively and the subscripts i and j represent the position of each grid in the reservoir; there are matrix system and micro-fracture system in each grid, constituting a dual medium model; the initial pressure of the matrix system and the micro-fracture system is the original formation pressure, and the water saturation of the matrix system and the micro-fracture system is the original formation water saturation, namely:

$$\{ \begin{matrix}{P}_{fwi , j , {t}_{0}} = {P}_{0} \\ {P}_{m w i , j , {t}_{0}} = {P}_{0}\end{matrix} \qquad ( 22 )$$

$$\{ \begin{matrix}{S}_{fwi , j , {t}_{0}} = {S}_{w , 0} \\ {S}_{m w i , j , {t}_{0}} = {S}_{w , 0}\end{matrix} \qquad ( 23 )$$

Where, P_{fw i,j,t0} and P_{mw i,j,t0} are the liquid pressure of micro-fracture and matrix systems at grid position (i,j) at t₀, in MPa; P₀ is the original formation pressure, in MPa; S_{fw i,j,t0} and S_{mw i,j,t0} are the water saturation of micro-fracture and matrix systems at grid position (i,j) at t₀; S_{w,0} is the original formation water saturation;

Based on the established reservoir grid, initial fracture units are added to the grid corresponding to the horizontal well fracturing position; When the initial fracture unit of each cluster is added to the reservoir grid, the direction of initial fracture unit of each cluster is designated as y-axis direction, and the length of initial fracture unit of each cluster is the length of N grids (N≥3);

It should be noted that when N is 1 or 2, the calculation accuracy is not satisfactory; the larger N is, the higher the calculation accuracy will be. In order to ensure the calculation efficiency, N can be directly set to 3 in the specific application of the present invention;

Step 2: Calculate the stress intensity factor at the eth fracture tip at t₀ based on the boundary element displacement discontinuity method, specifically including the following sub-steps:

Step 2-1: Assuming that the fluid pressure in each fracture unit is the same, the fluid pressure at the fracture tip is equal to the fluid pressure in the fracture unit at the fracture tip at t₀, that is:

P_{e,t}_{₀}=P_{F,L-e,t}_{₀} (24)

Where, P_{e,t0} is the fluid pressure at the e^{th} fracture tip at t₀, in MPa, and P_{F,L-e,t0} is the fluid pressure in the fracture unit located at the e^{th} fracture tip at t₀, in MPa;

Step 2-2: Determine the coordinates of the upper and lower tip positions of each fracture cluster in the x-y coordinate system according to the fracture unit position in t₀, which are respectively denoted as (x₁,y₁), . . . , (xₑ,yₑ);

Step 2-3: Take the center of the first fracture unit as the origin, the extension direction of the first fracture unit as the y̅ direction and the direction perpendicular to the extension of the first fracture unit as the x̅ direction, establish a local x̅-y̅ coordinate system, and convert the position coordinates of all fracture tips in Step 2-2 into the position coordinates in the local x̅-y̅ coordinate system, which are respectively denoted as (x̅₁, y̅₁), . . . , (x̅ₑ, y̅ₑ);

Step 2-4: Calculate the normal discontinuous displacement of the first, second, . . . , and n_{L}^{th} fracture unit at the e^{th} fracture tip at t₀;

In a specific embodiment, the normal discontinuous displacement of the first fracture unit at the e^{th} fracture tip at t₀ can be calculated by the following equation:

$${D}_{1 , e , {t}_{0}} = \frac{{P}_{e , {t}_{0}} - {σ}_{h}}{{A}_{xx ( 1 , e )} {sin}^{2} ( 2 {α}_{1} ) - {A}_{xy ( 1 , e )} sin {α}_{1} + {A}_{yy ( 1 , e )} {cos}^{2} ( 2 {α}_{1} )} \qquad ( 1 )$$

$$\{ \begin{matrix}{A}_{xx ( 1 , e )} = \frac{E}{1 + υ} [ {f}_{a ( 1 , e )} + {\overline{y}}_{e} ( sin {α}_{1} \times {f}_{c ( 1 , e )} + cos {a}_{1} \times {f}_{b ( 1 , e )} ) ] \\ {A}_{yy ( 1 , e )} = \frac{E}{1 + υ} [ {f}_{a ( 1 , e )} - {\overline{y}}_{e} ( sin {a}_{1} \times {f}_{c ( 1 , e )} + cos {a}_{1} \times {f}_{b ( 1 , e )} ) ] \\ {A}_{x , y ( 1 , e )} = \frac{E}{1 + υ} [ - {\overline{y}}_{e} ( cos {α}_{1} \times {f}_{c ( 1 , e )} + sin {α}_{1} \times {f}_{b ( 1 , e )} ) ]\end{matrix} \qquad ( 2 )$$

$$\{ \begin{matrix}{f}_{a ( 1 , e )} = \frac{- 1}{4 π ( 1 - υ )} [ \frac{{\overline{x}}_{e} - \frac{{ξ}_{1}}{2}}{{( {\overline{x}}_{e} - \frac{{ξ}_{1}}{2} )}^{2} + {\overline{y}}_{e}^{2}} - \frac{{\overline{x}}_{e} + \frac{{ξ}_{1}}{2}}{{( {\overline{x}}_{e} - + \frac{{ξ}_{1}}{2} )}^{2} + {\overline{y}}_{e}^{2}} ] \\ {f}_{b ( 1 , e )} = \frac{1}{4 π ( 1 - υ )} [ \frac{{( {\overline{x}}_{e} - \frac{{ξ}_{1}}{2} )}^{2} - {\overline{y}}_{e}^{2}}{{[ {( {\overline{x}}_{e} - \frac{{ξ}_{1}}{2} )}^{2} + {\overline{y}}_{e}^{2} ]}^{2}} - \frac{{( {\overline{x}}_{e} + \frac{{ξ}_{1}}{2} )}^{2} - {\overline{y}}_{e}^{2}}{{[ {( {\overline{x}}_{e} + \frac{{ξ}_{1}}{2} )}^{2} + {\overline{y}}_{e}^{2} ]}^{2}} ] \\ {f}_{c ( 1 , e )} = \frac{2 {\overline{y}}_{e}}{4 π ( 1 - υ )} [ \frac{{\overline{x}}_{e} - \frac{{ξ}_{1}}{2}}{{[ {( {\overline{x}}_{e} - \frac{{ξ}_{1}}{2} )}^{2} + {\overline{y}}_{e}^{2} ]}^{2}} - \frac{{\overline{x}}_{e} + \frac{{ξ}_{1}}{2}}{{[ {( {\overline{x}}_{e} + \frac{{ξ}_{1}}{2} )}^{2} + {\overline{y}}_{e}^{2} ]}^{2}} ]\end{matrix} \qquad ( 3 )$$

Where, D_{1,e,t0} is the normal discontinuous displacement generated by the first fracture unit at the e^{th} fracture tip at t₀, in mm; P_{e,t0} is the fluid pressure at the e^{th} fracture tip at t₀, in MPa; σₕ is the minimum horizontal principal stress of the reservoir, in MPa; A_{xx(1,e)}, A_{xy(1,e)}, A_{yy(1,e)}, f_{a(1,e)}, f_{b(1,e)} and f_{c(1,e)} are all intermediate functions in the calculation process; α1 is the angle between the x-axis of the local x̅-y̅ coordinate system of the first fracture unit and the x̅-axis of the x-y coordinate system; E is Young's modulus of reservoir rocks, in GPa; υ is Poisson's ratio of reservoir rock; x̅ₑ and y̅ₑ are the coordinates of the e^{th} fracture tip in the local x̅-y̅ coordinate system of the first fracture unit; ξ₁ is the length of the first fracture unit, in m;

The method for calculating the normal discontinuous displacement of the second, . . . , n_{L}^{th} fracture unit at the e^{th} fracture tip at t₀ is the same as that for the normal discontinuous displacement of the first fracture unit at the e^{th} fracture tip at t₀, so that Equations (1) to (3) are used to calculated the normal discontinuous displacement of the second, . . . , and n_{L}^{th} fracture unit at the e^{th} fracture tip at t₀;

Step 2-5: Overlay all the normal discontinuous displacements at the e^{th} fracture tip calculated in Step 2-4, and calculate the stress intensity factor at the e^{th} fracture tip at t₀ with the stress intensity factor calculation model at the fracture tip on the basis of the overlaid normal discontinuous displacement;

In a specific embodiment, the calculation model of the stress intensity factor at the fracture tip is as follows:

$${K}_{I , e , {t}_{0}} = \frac{E}{4 ( 1 - {υ}^{2} )} \sqrt{\frac{π}{2 {r}_{e}}} {D}_{e , {t}_{0}} \qquad ( 4 )$$

$${D}_{e , {t}_{0}} = {\sum }_{L = 1}^{{n}_{L}} {D}_{L , e , {t}_{0}} \qquad ( 5 )$$

Where, K_{I,e,t0} is the stress intensity factor at the e^{th} fracture tip at t₀, in MPa\sqrt{m}; rₑ is the half length of fracture unit at the e^{th} fracture tip, in mm; D_{e,t0} is the total normal discontinuous displacement at the e^{th} fracture tip at t₀, in mm; D_{L,e,t0} is the normal discontinuous displacement generated by the L^{th} fracture unit at the tip of the e¹ fracture at t₀, in mm;

It should be noted that there are many models for calculating the stress intensity factor in the prior art, but the present invention requires the coupling between the fracture propagation and the reservoir fluid flow; therefore, the above boundary element displacement discontinuity method is employed to calculate the stress intensity factor. This method is similar to the embedded discrete fracture model in terms of fracture discretization idea, both of which are solved by discretizing the hydraulic fractures into individual fracture units, thus enabling a smooth coupling between the fracture propagation and the reservoir fluid flow;

Step 3: Determine whether the fracture propagates at the e^{th} fracture tip at t₀ according to the stress intensity factor at the e^{th} fracture tip at t₀:

If the fracture does not propagate at the e^{th} fracture tip, repeat Steps 2 and 3, calculate the stress intensity factor at the e+1^{th} fracture tip at t₀, and judge whether the fracture propagates at the e+1^{th} fracture tip at t₀;

If the fracture propagates at the e^{th} fracture tip, the fracture at the e^{th} fracture tip is increased by one fracture unit in the direction of the e^{th} fracture tip, and the total number of fracture units is n_{L}=n_{L}+1; the fluid pressure of the added fracture unit is the same as that of the adjacent fracture unit, and the initiation time of the added fracture unit is designated as T_{F,nL+1}=t₀; repeat Steps 2 and 3, calculate the stress intensity factor at the e+1^{th} fracture tip at t₀ based on the data after adding the fracture unit, and judge whether the fracture propagates at the e+1^{th} fracture tip at t₀;

After the judgment of fracture propagation at all fracture tips, the total number n_{L,t0} of fracture units after fracture propagation at t₀ can be obtained, and the number of fracture unit is L=1,2, . . . , n_{L,t0}−1, and n_{L,t0}; the initiation time of the L^{th} fracture unit at t₀ is defined as T_{F,L,t0} and the fluid pressure in the L^{th} fracture unit at t₀ as P_{F,L,t0};

In a specific embodiment, the method to judge whether the fracture propagates at the e^{th} fracture tip at t₀ is as follows: the stress intensity factor K_{I,e,t0} at the e^{th} fracture tip at t₀ is compared with the fracture toughness K_{IC} of the reservoir rock: if K_{I,e,t0}≤K_{IC}, the fracture does not propagate at the e^{th} fracture tip; if K_{I,e,t0}>K_{IC}, the fracture will propagate at the e^{th} fracture tip;

Step 4: Based on the data obtained in Step 3, employ the gas-water dual medium seepage model for numerical calculation in combination with the embedded discrete fractures to obtain the fluid pressure of hydraulic fracture units, the pressure distribution in the matrix system, the water saturation distribution in the matrix system, the pressure distribution in the micro-fracture system, and the water saturation distribution in the micro-fracture system at ti during fracturing operation; the gas-water dual medium seepage model includes:

(1) Model of leak-off from hydraulic fracture unit to micro-fracture:

$${Q}_{F - f w} = \frac{C}{\sqrt{T - {T}_{F}}} \frac{2 {K}_{f} {l}_{F} H}{{μ}_{w} {\overline{d}}_{F - f}} ( {P}_{F} - {P}_{f w} ) \qquad ( 6 )$$

$${\overline{d}}_{F - f} = \frac{1}{{A}_{f}} \int {l}_{F - f} d {A}_{f} \qquad ( 7 )$$

Where, Q_{F-fw} is the leak-off between the hydraulic fracture unit and the micro-fracture grid, in m³; C is the leak-off coefficient; T is the current moment, in s; T_{F} is the initiation time of hydraulic fracture unit, T_{F}=T_{F,L,t0} and L=1, 2, . . . , n_{L,t0}−1, n_{L,t0}; K_{f} is the permeability of micro-fracture grid, D; l_{F} is the length of hydraulic fracture unit, in m, l_{F}=ξ_{L} and L=1, 2, . . . , n_{L,t0}−1,n_{L,t0}; H is reservoir thickness, in in; μ_{w} is the viscosity of fracturing fluid, in mPa·s; d̅_{F-f} is the average normal distance from one point in the micro-fracture grid to one hydraulic fracture unit, in m; P_{F} is the fluid pressure of hydraulic fracture unit, in MPa, P_{F}=P_{F,L,t0 0} and L=1, 2, . . . , n_{L,t0}−1,n_{L,t0}; P_{fw} is the water pressure of micro-fracture grid, in MPa; A_{f} is the area of micro-fracture grid, in m²; l_{F-f} is the distance between the area unit of micro-fracture grid and the fracture k, in m;

(2) Single-phase flow in hydraulic fracturing:

$$\frac{\partial }{\partial ξ} ( \frac{β {K}_{F}}{{μ}_{w} {B}_{w}} \frac{\partial {P}_{F}}{\partial ξ} ) + {δ}_{well} \frac{{q}_{{F}_{w}}}{{V}_{F}} + \frac{{Q}_{F - f w}}{{V}_{F}} = \frac{\partial }{\partial t} ( \frac{{ϕ}_{F}}{{B}_{w}} ) \qquad ( 8 )$$

$${q}_{F w} = \frac{2 π β {K}_{F} {w}_{F} ( {P}_{F} - {P}_{w f} )}{{μ}_{w} {B}_{w} [ ln ( \frac{{r}_{e q}}{{r}_{well}} ) + s ]} \qquad ( 9 )$$

$${r}_{e q} = 0.1 {4 [ {( {l}_{F} )}^{2} + {( {H}_{F} )}^{2} ]}^{1 / 2} \qquad ( 10 )$$

Where, β is the unit conversion coefficient; K_{F} is the permeability of hydraulic fracture, D; B_{w} is the volume coefficient of fracturing fluid; δ_{well} is the coefficient to judge the intersection relationship between hydraulic fracture unit and wellbore; if the fracture unit intersects with the wellbore, δ_{well}=1, if not intersect, δ_{well}=0; q_{Fw} is flow exchange between hydraulic fracture unit and wellbore, in m³; V_{F} is the volume of hydraulic fracture unit, in m³; ϕ_{F} is the porosity of hydraulic fracture, in %; w_{F} is the width of hydraulic fracture unit, in m; P_{wf} is the flow pressure at the bottom of the well, in MPa; r_{eq} is effective radius, in m; r_{well} is wellbore radius, in m; s is surface coefficient; H_{F} is the height of hydraulic fracture unit, in m;

(3) Seepage model of matrix and micro-fracture systems during fracturing:

$$∇ ( β \frac{{K}_{f} {K}_{frw}}{{μ}_{w} {B}_{w}} ∇ {P}_{fw} ) - {δ}_{f} \frac{{Q}_{F - f w}}{{V}_{f}} + \frac{β {K}_{m} {K}_{mrw}}{{μ}_{w} {B}_{w}} ( {P}_{m w} - {P}_{f w} ) = \frac{\partial }{\partial t} ( \frac{{ϕ}_{f} {S}_{fw}}{{B}_{w}} ) \qquad ( 11 )$$

$$∇ ( β \frac{{K}_{f} {K}_{f r g}}{{μ}_{g} {B}_{g}} ∇ {P}_{fg} ) + \frac{β {K}_{m} {K}_{m r g}}{{μ}_{g} {B}_{g}} ( {P}_{m g} - {P}_{f g} ) = \frac{\partial }{\partial t} ( \frac{{ϕ}_{f} {S}_{fg}}{{B}_{g}} ) \qquad ( 12 )$$

$$∇ ( β \frac{{K}_{m} {K}_{mrw}}{{μ}_{w} {B}_{w}} ∇ {P}_{m w} ) - \frac{β {K}_{m} {K}_{m r w}}{{μ}_{w} {B}_{w}} ( {P}_{m w} - {P}_{f w} ) = \frac{\partial }{\partial t} ( \frac{{ϕ}_{m} {S}_{m w}}{{B}_{w}} ) \qquad ( 13 )$$

$$∇ ( β \frac{{K}_{m} {K}_{m r g}}{{μ}_{g} {B}_{g}} ∇ {P}_{m g} ) - \frac{β {K}_{m} {K}_{m r g}}{{μ}_{g} {B}_{g}} ( {P}_{m g} - {P}_{fg} ) = \frac{\partial }{\partial t} ( \frac{{ϕ}_{m} {S}_{m g}}{{B}_{g}} ) \qquad ( 14 )$$

$${P}_{m c} = {P}_{m g} - {P}_{m w} \qquad ( 15 )$$

$${P}_{fc} = {P}_{fg} - {P}_{fw} \qquad ( 16 )$$

Where, ∇ is Hamiltonian operator; and K_{frw} and K_{frg} are the relative permeability of liquid and gas in the micro-fracture grid; δ_{f} is the parameter for judging whether the micro-fracture grid contains hydraulic fractures, when the micro-fracture grid is crossed by hydraulic fractures, δ_{f}=1; when the micro-fracture grid is not crossed by hydraulic fractures, δ_{f}=0; V_{f} is the volume of micro-fracture grid, in m³; Kₘ is matrix permeability, in mD; K_{mrw} and K_{mrg} are the relative permeability of liquid and gas in the micro-fracture grid; P_{mw} and P_{mg} are the pressure of liquid and gas in the matrix grid, in MPa; ϕ_{f} and ϕₘ are the porosity of micro-fracture and matrix, in %; S_{fw} and S_{fg} are the saturation of the liquid and gas in the micro-fracture grid; μ_{g} is the viscosity of gas, in mPa·s; B_{g} is the volume coefficient of gas; P_{fg} is the gas pressure of the micro-fracture grid, in MPa; S_{mw} and S_{mg} are the saturation of liquid and gas in the matrix grid; P_{fc} and P_{mc} are capillary forces of micro-fracture and matrix, in MPa;

(4) Initial conditions:

$$\{ \begin{matrix}{P}_{F} ( L ) = {P}_{F , L , {t}_{0}} \\ {P}_{f w} ( i , j ) = {P}_{fwi , j , {t}_{0}} \\ {P}_{m w} ( i , j ) = {P}_{mwi , j , {t}_{0}}\end{matrix} \qquad ( 17 )$$

$$\{ \begin{matrix}{S}_{f w} ( i , j ) = {S}_{fwi , j , {t}_{0}} \\ {S}_{m w} ( i , j ) = {S}_{mwi , j , {t}_{0}}\end{matrix} \qquad ( 18 )$$

$$\{ \begin{matrix}{T}_{F} ( L ) = {T}_{F , L , {t}_{0}} \\ T = {t}_{0}\end{matrix} \qquad ( 19 )$$

Where, P_{F}(L) is the fluid pressure of the L^{th} fracture unit in the seepage model calculation, in MPa; P_{fw(i,j)} and P_{mw(i,j)} are the liquid pressure of micro-fracture and matrix systems at the grid position of (i,j) in seepage model calculation, in MPa; P_{fw i,j,t0} and P_{mw i,j,t0} are the liquid pressure of micro-fracture and matrix systems at grid position (i,j) at t₀, in MPa; S_{fw(i,j)} and S_{mw(i,j)} are the water saturation of micro-fracture and matrix systems at the grid position of (i,j) in seepage model calculation; S_{fw i,j,t0} and S_{mw i,j,t0} are the water saturation of micro-fracture and matrix systems at grid position (i,j) at t₀; T_{F(L)} is the initiation time of the L^{th} fracture unit in the seepage model calculation, in s; T is the current time, in s;

Step 5: Based on the data obtained in Step 4, repeat Step 2 to 4, and calculate the fluid pressure in the hydraulic fracture unit, the pressure distribution in the matrix system, the water saturation distribution in the matrix system, the pressure distribution in the micro-fracture system, and the water saturation distribution in the micro-fracture system at t₂;

Step 6: Repeat Step 5 until the time reaches the fracturing time t_{end} to obtain the number of hydraulic fracture units, water saturation distribution of matrix system and water saturation distribution of micro-fracture system at t_{end};

Step 7: Calculate the stimulated reservoir volume at t_{end} according to the data obtained in Step 6; the stimulated reservoir volume can be calculated by the following equation:

$${V}_{0} = {\sum }_{i = 1}^{{n}_{i}} {\sum }_{j = 1}^{{n}_{j}} {α}_{1 , i , j} {x}_{i , j} {y}_{i , j} H {ϕ}_{m} + {\sum }_{i = 1}^{{n}_{i}} {\sum }_{j = 1}^{{n}_{j}} {α}_{2 , i , j} {x}_{i , j} {y}_{i , j} H {ϕ}_{f} + {L}_{F , {t}_{end}} {w}_{F} H \qquad ( 20 )$$

$${L}_{F , {t}_{e n d}} = {n}_{L , {t}_{e n d}} \times {ξ}_{L} \qquad ( 21 )$$

Where, V₀ is the stimulated reservoir volume, in m³; α_{1,i,j} is the judgment parameter of the fracturing stimulation range in the matrix system; when S_{mw i,j,tend}>S_{mw i,j,t0}, the matrix system at the (i,j) grid position is stimulated and α1,i,j=1; when S_{mw i,j,tend}≤S_{mw i,j,t0}, α_{1,i,j}=0; H is reservoir thickness, in m; ϕₘ is the porosity of the matrix, in %; α_{2,i,j} is the judgment parameter of the fracturing stimulation range in the micro-fracture system; when S_{fw i,j,tend}>S_{fw i,j,t0}, the micro-fracture system at the (i,j) grid position is stimulated and α_{2,i,j}=1; when S_{fw i,j,tend}≤S_{fw i,j,t0}, α_{2,i,j}=0; ϕ_{f} is the porosity of micro-fracture, in %; L_{F,tend} is the length of hydraulic fracture after fracturing, in m; n_{L,tend} is the number of hydraulic fracture units at t_{end}.

In a specific embodiment, taking a shale gas well in a certain block in the southern Sichuan area as an example, the method of determining the stimulated reservoir volume of horizontal wells by coupling reservoir flow described in the present invention is used for simulation and calculation to obtain the stimulated reservoir volume after hydraulic fracturing. The specific calculation steps are as follows:

(1) Establish a structured grid in the rectangular coordinate system based on the reservoir conditions, with the length and width of each grid set to 1 m; the whole reservoir is divided into a structured grid of 180×350, namely, nᵢ=180 and nⱼ=350. Assign values to the micro-fracture system and matrix system at each reservoir grid with the original formation pressure P₀=40 MPa and the original formation water saturation S_{w,0}=0.3 through Equations (22) to (23), namely, P_{fw i,j,t0}=P_{mw i,j,t0}=40 MPa and S_{fw i,j,t0}=S_{mw i,j,t0}=0.3.

(2) Add six initial hydraulic fractures with cluster spacing of 20 m on the basis of the established grid, each of which has a length of 3 m and is divided into 3 fracture units by the reservoir grid. At this point, the total number is U=12 for hydraulic fracture tips and n_{L}=18 for hydraulic fracture units, the length of each hydraulic fracture unit is ξ_{L}=1 m, the fluid pressure inside each fracture unit is P_{F,1}=P_{F,2}= . . . =P_{F,18}=40 MPa, and the initiation time of each fracture unit is T_{F,1}=T_{F,2}= . . . =T_{F,18}=0 s.

(3) Based on the established reservoir grid and fracture unit, obtain the fluid pressures P_{1,0,} P_{2,0}, . . . P_{12,0} at 12 fracture tips by Equation (24).

(4) Calculate the stress intensity factor K_{1,1,0} at the first fracture tip by Equations (1) to (5) when t=0 s and compare it with the fracture toughness K_{IC}=2 MPa\sqrt{m} of shale reservoir; if K_{1,1,0}>K_{IC}, the fracture propagates at the first fracture tip, the total grid number of hydraulic fractures is n_{L}=n_{L}+1, the fluid pressure of the added fracture unit is assigned by the fluid pressure in the adjacent fracture unit, and the initiation time of the added fracture unit is set to 0 s; if K_{I,1,0}≤K_{IC}, the fracture does not propagate at the first fracture tip and the fracture length remains unchanged.

(5) Continue to calculate the stress intensity factors K_{I,2,0}, K_{I,3,0} . . . K_{I,12,0} at the tips of the second to twelfth fractures, compare the results with K_{IC} to obtain the fracture propagation at each fracture tip, and finally obtain the total number L,0 of fracture units after fracture propagation at t=0 s; the initiation time of each fracture unit is set to T_{F,1,0,} T_{F,2,0} . . . T_{F,nL,0,0} and the fluid pressure in each fracture unit is set to P_{F,1,0,} P_{F,2,0} . . . P_{F,nL,0,0}.

(6) Convert the parameters worked out in Steps (1) to (5) into the initial conditions of the numerical simulation model through Equations (17) to (19).

(7) Calculate the fluid pressure P_{F,1,1}, P_{F,2,1} . . . P_{F,nL,0,1} of each hydraulic fracture unit at t=1 s by Equations (6) to (16); set the pressure distribution of each matrix grid as P_{mw i,j,l}, the water saturation distribution of each matrix grid as S_{mw i,j,l}, the pressure distribution of each micro-fracture grid as P_{fw i,j,l}, and the water saturation distribution of each micro-fracture grid as S_{fw i,j,l}. In this embodiment, the fluid leak-off coefficient is C=0.5 and the unit width of hydraulic fracture is w_{F}=0.004 m.

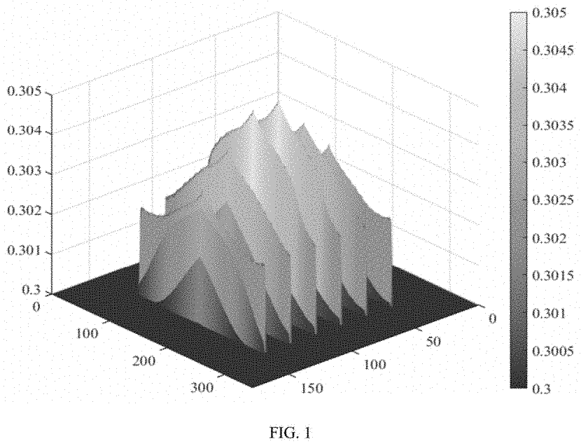

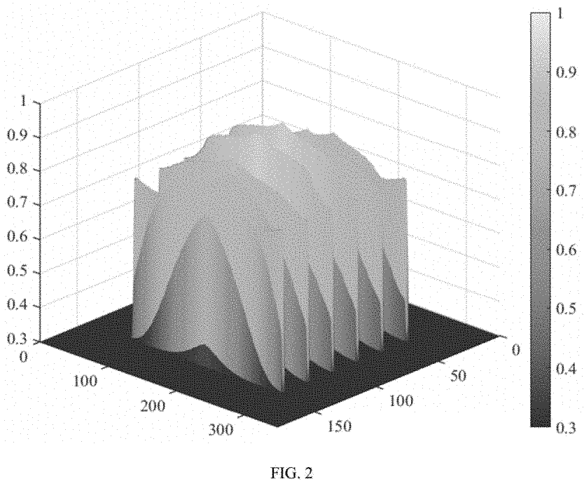

(8) Based on the parameters obtained in Step (7), repeat Steps (2) to (7) to calculate the parameters of reservoir matrix, micro-fracture and hydraulic fracture at t=2 s; make the calculation until t=t_{end} when fracturing operation is completed; after the calculation, work out the total number n_{L,tend} of hydraulic fracture units, the water saturation S_{mw i,j,tend} at different locations of reservoir matrix, and the water saturation S_{fw i,j,tend} at different locations of micro-fracture system; the water saturation distribution results of matrix and micro-fracture systems are shown in FIG. 1-2.

(9) Calculate the total length L_{F,tend} of 6 hydraulic fractures according to the parameters obtained in Step (8) and Equation (21).

(10) According to the parameters obtained in Step (8), obtain the judgment parameters α_{1,i,j} and α_{2,i,j} for the fracturing stimulation range in the matrix system and micro-fracture system through comparison with the initial water saturation.

(11) According to the parameters obtained in Steps (8) to (10) and Equation (20), calculate the fracturing stimulation volume, namely, V₀=18,841.44 m³.

In the present invention, the flow of reservoir fluid during fracturing operation is considered, the stimulated reservoir volume is calculated on the basis of the obtained reservoir water saturation field and the fracturing fluid leak-off, so that the calculation results are more in line with reality, which is significantly improved compared with the prior art.

The above are only the preferred embodiments, which are not intended to limit the present invention in any form. Although the present invention has been disclosed as above with preferred embodiments, it is not intended to limit the present invention. Those skilled in the art, within the scope of the technical solution of the present invention, can use the disclosed technical content to make a few changes or modify the equivalent embodiment with equivalent changes. Within the scope of the technical solution of the present invention, any simple modification, equivalent change and modification made to the above embodiments according to the technical essence of the present invention are still regarded as a part of the technical solution of the present invention.

What is claimed is:

1. A method for determining the stimulated reservoir volume of horizontal wells by coupling reservoir flow, comprising the following steps:
Step 1: Obtain the reservoir geological model of the target well, establish the reservoir grid of the target well based on the reservoir geological model, and add the initial fracture of each cluster to the reservoir grid, making initial fractures divided into multiple fracture units by the reservoir grid;
The total number of hydraulic fracture tips in the reservoir grid is defined as U, and the number of fracture tips is e, then e=1, 2 . . . , U−1 and U; if e is an odd number, it represents the upper tip of the fracture, and if e is an even number, it represents the lower tip of the fracture; let n_{L} denote the total number of fracture units and let L denote the fracture unit number, then L=1, 2 . . . n_{L}−1 and n_{L}; let ξ_{L} represent the length of the L^{th} fracture unit, P_{F,L} represent the fluid pressure in the L^{th} fracture unit, T_{F,L} represent the initiation time of the L^{th} fracture unit, and to represent the initiation time of the initial fracture unit of each cluster;
Step 2: Calculate the stress intensity factor at the e^{th} fracture tip at t₀ based on the boundary element displacement discontinuity method;
Step 3: Determine whether the fracture propagates at the e^{th} fracture tip at t₀ according to the stress intensity factor at the e^{th} fracture tip at t₀:
If the fracture does not propagate at the e^{th} fracture tip, repeat Steps 2 and 3, calculate the stress intensity factor at the e+1^{th} fracture tip at t₀, and judge whether the fracture propagates at the e+1^{th} fracture tip at t₀;
If the fracture propagates at the e^{th} fracture tip, the fracture at the e^{th} fracture tip is increased by one fracture unit in the direction of the e^{th} fracture tip, and the total number of fracture units is n_{L}=n_{L}+1; the fluid pressure of the added fracture unit is the same as that of the adjacent fracture unit, and the initiation time of the added fracture unit is designated as T_{F,nL+1}=t₀; repeat Steps 2 and 3, calculate the stress intensity factor at the e+1^{th} fracture tip at t₀ based on the data after adding the fracture unit, and judge whether the fracture propagates at the e+1^{th} fracture tip at t₀;
After the judgment of fracture propagation at all fracture tips, the total number of fracture units n_{L,t0} after fracture propagation at t₀ can be obtained, and the number of fracture unit is L=1,2, . . . , n_{L,t0}−1, and n_{L,t0}; the initiation time of the L^{th} fracture unit at t₀ is defined as T_{F,L,t0} and the fluid pressure in the L^{th} fracture unit at t₀ is P_{F,L,t0};
Step 4: Based on the data obtained in Step 3, employ the gas-water dual medium seepage model for numerical calculation in combination with the embedded discrete fractures to obtain the fluid pressure of hydraulic fracture units, the pressure distribution in the matrix system, the water saturation distribution in the matrix system, the pressure distribution in the micro-fracture system, and the water saturation distribution in the micro-fracture system at t₁ during fracturing operation;
Step 5: Based on the data obtained in Step 4, repeat Step 2 to 4, and calculate the fluid pressure in the hydraulic fracture unit, the pressure distribution in the matrix system, the water saturation distribution in the matrix system, the pressure distribution in the micro-fracture system, and the water saturation distribution in the micro-fracture system at t₂;
Step 6: Repeat Step 5 until the time reaches the fracturing time tend to obtain the number of hydraulic fracture units, water saturation distribution of matrix system and water saturation distribution of micro-fracture system at t_{end};
Step 7: Calculate the stimulated reservoir volume at tend according to the data obtained in Step 6.

2. The method for determining the stimulated reservoir volume of horizontal wells by coupling reservoir flow according to claim 1, wherein in Step 1, the reservoir grid is a structured grid with a grid number of nᵢ×nⱼ in x-y coordinate system, wherein x_{i,j} and y_{i,j} represent the length and width of each grid respectively and the subscripts i and j represent the position of each grid in the reservoir; there are matrix system and micro-fracture system in each grid, constituting a dual medium model; the initial pore pressure of the matrix system and the micro-fracture system is the original formation pressure, and the water saturation of the matrix system and the micro-fracture system is the original formation water saturation.

3. The method for determining the stimulated reservoir volume of horizontal wells by coupling reservoir flow according to claim 2, wherein in Step 1, when the initial fracture unit of each cluster is added to the reservoir grid, the direction of initial fracture unit of each cluster is designated as y-axis direction, and the length of initial fracture unit of each cluster is the length of N grids (N≥3).

4. The method for determining the stimulated reservoir volume of horizontal wells by coupling reservoir flow according to claim 1, wherein Step 2 specifically comprises the following sub-steps:
Step 2-1: Assuming that the fluid pressure in each fracture unit is the same, the fluid pressure at the fracture tip is equal to the fluid pressure in the fracture unit at the fracture tip at t₀;
Step 2-2: Determine the coordinates of the upper and lower tip positions of each fracture cluster in the x-y coordinate system according to the fracture unit position in t₀, which are respectively denoted as (x₁,y₁), . . . , (xₑ,yₑ);
Step 2-3: Take the center of the first fracture unit as the origin, the extension direction of the first fracture unit as the y̅ direction and the direction perpendicular to the extension of the first fracture unit as the x̅ direction, establish a local x̅-y̅ coordinate system, and convert the position coordinates of all fracture tips in Step 2-2 into the position coordinates in the local x̅-y̅ coordinate system, which are respectively denoted as (x̅₁, y̅₁), . . . , (x̅ₑ, y̅ₑ);
Step 2-4: Calculate the normal discontinuous displacement of the first, second, . . . , and n_{L}^{th} fracture unit at the e^{th} fracture tip at t₀;
Step 2-5: Overlay all the normal discontinuous displacements at the e^{th} fracture tip calculated in Step 2-4, and calculate the stress intensity factor at the e^{th} fracture tip at t₀ with the stress intensity factor calculation model at the fracture tip on the basis of the overlaid normal discontinuous displacement.

5. The method for determining the stimulated reservoir volume of horizontal wells by coupling reservoir flow according to claim 4, wherein in Step 2-4, the normal discontinuous displacement of the first fracture unit at the e^{th} fracture tip at t₀ can be calculated by the following equation:
$${D}_{1 , e , {t}_{0}} = \frac{{P}_{e , {t}_{0}} - {σ}_{h}}{{A}_{xx ( 1 , e )} {sin}^{2} ( 2 {α}_{1} ) - {A}_{xy ( 1 , e )} sin {α}_{1} + {A}_{yy ( 1 , e )} {cos}^{2} ( 2 {α}_{1} )} \qquad ( 1 )$$
$$\{ \begin{matrix}{A}_{xx ( 1 , e )} = \frac{E}{1 + υ} [ {f}_{a ( 1 , e )} + {\overline{y}}_{e} ( sin {α}_{1} \times {f}_{c ( 1 , e )} + cos {a}_{1} \times {f}_{b ( 1 , e )} ) ] \\ {A}_{yy ( 1 , e )} = \frac{E}{1 + υ} [ {f}_{a ( 1 , e )} - {\overline{y}}_{e} ( sin {a}_{1} \times {f}_{c ( 1 , e )} + cos {a}_{1} \times {f}_{b ( 1 , e )} ) ] \\ {A}_{x , y ( 1 , e )} = \frac{E}{1 + υ} [ - {\overline{y}}_{e} ( cos {α}_{1} \times {f}_{c ( 1 , e )} + sin {α}_{1} \times {f}_{b ( 1 , e )} ) ]\end{matrix} \qquad ( 2 )$$
$$\{ \begin{matrix}{f}_{a ( 1 , e )} = \frac{- 1}{4 π ( 1 - υ )} [ \frac{{\overline{x}}_{e} - \frac{{ξ}_{1}}{2}}{{( {\overline{x}}_{e} - \frac{{ξ}_{1}}{2} )}^{2} + {\overline{y}}_{e}^{2}} - \frac{{\overline{x}}_{e} + \frac{{ξ}_{1}}{2}}{{( {\overline{x}}_{e} - + \frac{{ξ}_{1}}{2} )}^{2} + {\overline{y}}_{e}^{2}} ] \\ {f}_{b ( 1 , e )} = \frac{1}{4 π ( 1 - υ )} [ \frac{{( {\overline{x}}_{e} - \frac{{ξ}_{1}}{2} )}^{2} - {\overline{y}}_{e}^{2}}{{[ {( {\overline{x}}_{e} - \frac{{ξ}_{1}}{2} )}^{2} + {\overline{y}}_{e}^{2} ]}^{2}} - \frac{{( {\overline{x}}_{e} + \frac{{ξ}_{1}}{2} )}^{2} - {\overline{y}}_{e}^{2}}{{[ {( {\overline{x}}_{e} + \frac{{ξ}_{1}}{2} )}^{2} + {\overline{y}}_{e}^{2} ]}^{2}} ] \\ {f}_{c ( 1 , e )} = \frac{2 {\overline{y}}_{e}}{4 π ( 1 - υ )} [ \frac{{\overline{x}}_{e} - \frac{{ξ}_{1}}{2}}{{[ {( {\overline{x}}_{e} - \frac{{ξ}_{1}}{2} )}^{2} + {\overline{y}}_{e}^{2} ]}^{2}} - \frac{{\overline{x}}_{e} + \frac{{ξ}_{1}}{2}}{{[ {( {\overline{x}}_{e} + \frac{{ξ}_{1}}{2} )}^{2} + {\overline{y}}_{e}^{2} ]}^{2}} ]\end{matrix} \qquad ( 3 )$$
Where, D_{1,e,t0} is the normal discontinuous displacement generated by the first fracture unit at the e^{th} fracture tip at t₀, in mm; P_{e,t0} is the fluid pressure at the e^{th} fracture tip at t₀, in MPa; σₕ is the minimum horizontal principal stress of the reservoir, in MPa; A_{xx(1,e)}, A_{xy(1,e)}, A_{yy(1,e)}, f_{a(1,e)}, f_{b(1,e)} and f_{c(1,e)} are all intermediate functions in the calculation process; α₁ is the angle between the x-axis of the local x̅-y̅ coordinate system of the first fracture unit and the x̅-axis of the x-y coordinate system; E is Young's modulus of reservoir rocks, in GPa; υ is Poisson's ratio of reservoir rock; x̅ₑ and y̅ₑ are the coordinates of the e^{th} fracture tip in the local x̅-y̅ coordinate system of the first fracture unit; ξ₁ is the length of the first fracture unit, in m;
In Step 2-4, the method for calculating the normal discontinuous displacement of the second, . . . , n_{L}^{th} fracture unit at the e^{th} fracture tip at t₀ is the same as that for the normal discontinuous displacement of the first fracture unit at the e^{th} fracture tip at t₀, so that Equations (1) to (3) are used to calculated the normal discontinuous displacement of the second, . . . , and n_{L}^{th} fracture unit at the e^{th} fracture tip at t₀.

6. The method for determining the stimulated reservoir volume of horizontal wells by coupling reservoir flow according to claim 5, wherein in Step 2-5, the calculation model of the stress intensity factor at the fracture tip is as follows:
$${K}_{I , e , {t}_{0}} = \frac{E}{4 ( 1 - {υ}^{2} )} \sqrt{\frac{π}{2 {r}_{e}}} {D}_{e , {t}_{0}} \qquad ( 4 )$$
$${D}_{e , {t}_{0}} = {\sum }_{L = 1}^{{n}_{L}} {D}_{L , e , {t}_{0}} \qquad ( 5 )$$
Where, K_{I,e,t0} is the stress intensity factor at the e^{th} fracture tip at t₀, in MPa\sqrt{m}; rₑ is the half length of fracture unit at the e^{th} fracture tip, in mm; D_{e,t0} is the total normal discontinuous displacement at the e^{th} fracture tip at t₀, in mm; D_{L,e,t0} is the normal discontinuous displacement generated by the L^{th} fracture unit at the tip of the e¹ fracture at t₀, in mm.

7. The method for determining the stimulated reservoir volume of horizontal wells by coupling reservoir flow according to claim 1, wherein in Step 3, the method to judge whether the fracture propagates at the e^{th} fracture tip at t₀ is as follows:
The stress intensity factor K_{I,e,t0} at the e^{th} fracture tip at t₀ is compared with the fracture toughness K_{IC} of the reservoir rock: if K_{I,e,t0}≤K_{IC}, the fracture does not propagate at the e^{th} fracture tip; if K_{I,e,t0}>K_{IC}, the fracture will propagate at the e^{th} fracture tip.

8. The method for determining the stimulated reservoir volume of horizontal wells by coupling reservoir flow according to claim 1, wherein in Step 4, the gas-water dual medium seepage model comprises:
(1) Model of leak-off from hydraulic fracture unit to micro-fracture:
$${Q}_{F - f w} = \frac{C}{\sqrt{T - {T}_{F}}} \frac{2 {K}_{f} {l}_{F} H}{{μ}_{w} {\overline{d}}_{F - f}} ( {P}_{F} - {P}_{f w} ) \qquad ( 6 )$$
$${\overline{d}}_{F - f} = \frac{1}{{A}_{f}} \int {l}_{F - f} d {A}_{f} \qquad ( 7 )$$
Where, Q_{F-fw} is the leak-off between the hydraulic fracture unit and the micro-fracture grid, in m³; C is the leak-off coefficient; T is the current moment, in s; T_{F} is the initiation time of hydraulic fracture unit, T_{F}=T_{F,L,t0} and L=1, 2, . . . , n_{L,t0}; K_{f} is the permeability of micro-fracture grid, D; l_{F} is the length of hydraulic fracture unit, in m, l_{F}=ξ_{L} and L=1, 2, . . . , n_{L,t0}−1,n_{L,t0}; H is reservoir thickness, in m; μ_{w} is the viscosity of fracturing fluid, in mPa·s; d̅_{F-f} is the average normal distance from one point in the micro-fracture grid to one hydraulic fracture unit, in m; P_{F} is the fluid pressure of hydraulic fracture unit, in MPa, P_{F}=P_{F,L,t0} and L=1, 2, . . . , n_{L,t0}−1,n_{L,t0}; P_{fw} is the water pressure of micro-fracture grid, in MPa; A_{f} is the area of micro-fracture grid, in m²; l_{F-f} is the distance between the area unit of micro-fracture grid and the fracture k, in m;
(2) Single-phase flow in hydraulic fracturing:
$$\frac{\partial }{\partial ξ} ( \frac{β {K}_{F}}{{μ}_{w} {B}_{w}} \frac{\partial {P}_{F}}{\partial ξ} ) + {δ}_{well} \frac{{q}_{{F}_{w}}}{{V}_{F}} + \frac{{Q}_{F - f w}}{{V}_{F}} = \frac{\partial }{\partial t} ( \frac{{ϕ}_{F}}{{B}_{w}} ) \qquad ( 8 )$$
$${q}_{F w} = \frac{2 π β {K}_{F} {w}_{F} ( {P}_{F} - {P}_{w f} )}{{μ}_{w} {B}_{w} [ ln ( \frac{{r}_{e q}}{{r}_{well}} ) + s ]} \qquad ( 9 )$$
$${r}_{e q} = 0.1 {4 [ {( {l}_{F} )}^{2} + {( {H}_{F} )}^{2} ]}^{1 / 2} \qquad ( 10 )$$
Where, β is the unit conversion coefficient; K_{F} is the permeability of hydraulic fracture, D; B_{w} is the volume coefficient of fracturing fluid; δ_{well} is the coefficient to judge the intersection relationship between hydraulic fracture unit and wellbore; if the fracture unit intersects with the wellbore, δ_{well}=1; if not intersect, δ_{well}=0; q_{Fw} is flow exchange between hydraulic fracture unit and wellbore, in m³; V_{F} is the volume of hydraulic fracture unit, in m³; ϕ_{F} is the porosity of hydraulic fracture, in %; w_{F} is the width of hydraulic fracture unit, in m; P_{wf} is the flow pressure at the bottom of the well, in MPa; r_{eq} is effective radius, in m; r_{well} is wellbore radius, in m; s is surface coefficient; H_{F} is the height of hydraulic fracture unit, in m;
(3) Seepage model of matrix and micro-fracture systems during fracturing:
$$∇ ( β \frac{{K}_{f} {K}_{frw}}{{μ}_{w} {B}_{w}} ∇ {P}_{fw} ) - {δ}_{f} \frac{{Q}_{F - f w}}{{V}_{f}} + \frac{β {K}_{m} {K}_{mrw}}{{μ}_{w} {B}_{w}} ( {P}_{m w} - {P}_{f w} ) = \frac{\partial }{\partial t} ( \frac{{ϕ}_{f} {S}_{fw}}{{B}_{w}} ) \qquad ( 11 )$$
$$∇ ( β \frac{{K}_{f} {K}_{f r g}}{{μ}_{g} {B}_{g}} ∇ {P}_{fg} ) + \frac{β {K}_{m} {K}_{m r g}}{{μ}_{g} {B}_{g}} ( {P}_{m g} - {P}_{f g} ) = \frac{\partial }{\partial t} ( \frac{{ϕ}_{f} {S}_{fg}}{{B}_{g}} ) \qquad ( 12 )$$
$$∇ ( β \frac{{K}_{m} {K}_{mrw}}{{μ}_{w} {B}_{w}} ∇ {P}_{m w} ) - \frac{β {K}_{m} {K}_{m r w}}{{μ}_{w} {B}_{w}} ( {P}_{m w} - {P}_{f w} ) = \frac{\partial }{\partial t} ( \frac{{ϕ}_{m} {S}_{m w}}{{B}_{w}} ) \qquad ( 13 )$$
$$∇ ( β \frac{{K}_{m} {K}_{m r g}}{{μ}_{g} {B}_{g}} ∇ {P}_{m g} ) - \frac{β {K}_{m} {K}_{m r g}}{{μ}_{g} {B}_{g}} ( {P}_{m g} - {P}_{fg} ) = \frac{\partial }{\partial t} ( \frac{{ϕ}_{m} {S}_{m g}}{{B}_{g}} ) \qquad ( 14 )$$
$${P}_{m c} = {P}_{m g} - {P}_{m w} \qquad ( 15 )$$
$${P}_{fc} = {P}_{fg} - {P}_{fw} \qquad ( 16 )$$
Where, ∇ is Hamiltonian operator; K_{frw} and K_{frg} are the relative permeability of liquid and gas in the micro-fracture grid; δ_{f} is the parameter for judging whether the micro-fracture grid contains hydraulic fractures, when the micro-fracture grid is crossed by hydraulic fractures, δ_{f}−1; when the micro-fracture grid is not crossed by hydraulic fractures, δ_{f}=0; V_{f} is the volume of micro-fracture grid, in m³; Kₘ is matrix permeability, in mD; K_{mrw} and K_{mrg} are the relative permeability of liquid and gas in the micro-fracture grid; P_{mw} and P_{mg} are the pressure of liquid and gas in the matrix grid, in MPa; ϕ_{f} and ϕₘ are the porosity of micro-fracture and matrix, in %; S_{fw} and S_{fg} are the saturation of the liquid and gas in the micro-fracture grid; μ_{g} is the viscosity of gas, in mPa·s; B_{g} is the volume coefficient of gas; P_{fg} is the gas pressure of the micro-fracture grid, in MPa; S_{mw} and S_{mg} are the saturation of liquid and gas in the matrix grid; P_{fc} and P_{mc} are capillary forces of micro-fracture and matrix, in MPa;
(4) Initial conditions:
$$\{ \begin{matrix}{P}_{F} ( L ) = {P}_{F , L , {t}_{0}} \\ {P}_{f w} ( i , j ) = {P}_{fwi , j , {t}_{0}} \\ {P}_{m w} ( i , j ) = {P}_{mwi , j , {t}_{0}}\end{matrix} \qquad ( 17 )$$
$$\{ \begin{matrix}{S}_{f w} ( i , j ) = {S}_{fwi , j , {t}_{0}} \\ {S}_{m w} ( i , j ) = {S}_{mwi , j , {t}_{0}}\end{matrix} \qquad ( 18 )$$
$$\{ \begin{matrix}{T}_{F} ( L ) = {T}_{F , L , {t}_{0}} \\ T = {t}_{0}\end{matrix} \qquad ( 19 )$$
Where, P_{F}(L) is the fluid pressure of the L^{th} fracture unit in the seepage model calculation, in MPa; P_{fw(i,j)} and P_{mw(i,j)} are the liquid pressure of micro-fracture and matrix systems at the grid position of (i,j) in seepage model calculation, in MPa; P_{fw i,j,t0} and P_{mw i,j,t0} are the liquid pressure of micro-fracture and matrix systems at grid position (i,j) at t₀, in MPa; S_{fw(i,j)} and S_{mw(i,j)} are the water saturation of micro-fracture and matrix systems at the grid position of (i,j) in seepage model calculation; S_{fw i,j,t0} and S_{mw i,j,t0} are the water saturation of micro-fracture and matrix systems at grid position (i,j) at t₀; T_{F(L)} is the initiation time of the L^{th} fracture unit in the seepage model calculation, in s; T is the current time, in s.

9. The method for determining the stimulated reservoir volume of horizontal wells by coupling reservoir flow according to claim 1, wherein in Step 7, the stimulated reservoir volume can be calculated by the following equation:
$${V}_{0} = {\sum }_{i = 1}^{{n}_{i}} {\sum }_{j = 1}^{{n}_{j}} {α}_{1 , i , j} {x}_{i , j} {y}_{i , j} H {ϕ}_{m} + {\sum }_{i = 1}^{{n}_{i}} {\sum }_{j = 1}^{{n}_{j}} {α}_{2 , i , j} {x}_{i , j} {y}_{i , j} H {ϕ}_{f} + {L}_{F , {t}_{end}} {w}_{F} H \qquad ( 20 )$$
$${L}_{F , {t}_{e n d}} = {n}_{L , {t}_{e n d}} \times {ξ}_{L} \qquad ( 21 )$$
Where, V₀ is the stimulated reservoir volume, in m³; α_{1,i,j} is the judgment parameter of the fracturing stimulation range in the matrix system; when S_{mw i,j,tend}>S_{mw i,j,t0}, the matrix system at the (i,j) grid position is stimulated and α1,i,j=1; when S_{mw i,j,tend}≤S_{mw i,j,t0}, α_{1,i,j}=0; H is reservoir thickness, in m; ϕₘ is the porosity of the matrix, in %; α_{2,i,j} is the judgment parameter of the fracturing stimulation range in the micro-fracture system; when S_{fw i,j,tend}>S_{fw i,j,t0}, the micro-fracture system at the (i,j) grid position is stimulated and α_{2,i,j}=1; when S_{fw i,j,tend}≤S_{fw i,j,t0}, α_{2,i,j}=0; ϕ_{f} is the porosity of micro-fracture, in %; L_{F,tend} is the length of hydraulic fracture after fracturing, in m; n_{L,tend} is the number of hydraulic fracture units at t_{end}.
